(19) United States
(12) Patent Application Publication
(10) Pub. No.: US 2026/0311418 A1
(43) Pub. Date: Oct. 8, 2026

(54) A METHOD FOR REVEALING THE SURFACE OF DENSE FORESTS USING REMOTE SENSING

(71) Applicant: RAFAEL ADVANCED DEFENSE SYSTEMS LTD., Haifa (IL)

(72) Inventors: Refael Sheffer, Haifa (IL); Roee Litman, Haifa (IL); Hen Pinchover, Haifa (IL); Dror Ozeri, Haifa (IL)

(21) Appl. No.: 19/482,011

(22) PCT Filed: Mar. 18, 2024
(86) PCT No.: PCT/IL2024/050281

§ 371 Date: Nov. 6, 2025

(30) Foreign Application Priority Data
Jun. 5, 2023 (IL) 303469

(51) Int. Cl. G06T 15/20; G06T 15/08

(52) U.S. Cl. CPC G06T 15/20; G06T 15/08

(57) ABSTRACT

A method for constructing under-the-canopy terrain imagery, the method comprises the steps of: a. capturing overlapping images to cover an area-of-interest from an imaging sensor on an aerial platform; b. performing bundle adjustment utilizing parameters of said imaging sensor at any given point of capturing the images; c. training a neural network model for implicit volumetric rendering, wherein said model is configured to generate simulated views from any point of said area-of-interest; and d. generating terrain images by discarding occluding objects above ground level from the scene.

### FIELD OF THE INVENTION

The invention is from the field of remote sensing. In particular it relates to remote sensing using aerial platforms to gather images of a geographical area. More particularly it relates to a method of imaging the terrain under densely forested areas.

### BACKGROUND OF THE INVENTION

Publications and other reference materials referred to herein are numerically referenced in the following text and respectively grouped in the appended Bibliography which immediately precedes the claims.

Traditional imaging methods often fail to provide accurate information about the terrain underneath the thick canopy of trees in densely forested areas. Accurate information about the surface below the forest canopy can be helpful for a number of applications, including:
creating accurate maps of the forest;
monitoring changes in the forest over time;
supporting conservation efforts by providing detailed information about the distribution and health of the vegetation;
aiding search and rescue operations by providing detailed information about the terrain and potential obstacles, allowing rescue teams to navigate through dense forests more efficiently and locate missing people faster; and
monitoring wildlife in forests, providing detailed information about their movements and habitat use.

It is therefore a purpose of the present invention to provide a method revealing the surface of forests.

Further purposes and advantages of this invention will appear as the description proceeds.

### SUMMARY OF THE INVENTION

The invention is a method for constructing under-the-canopy terrain imagery. The method comprises the steps:
a. capturing overlapping images to cover an area-of-interest from an imaging sensor on an aerial platform;
b. performing bundle adjustment utilizing parameters of said imaging sensor at any given point of capturing the images;
c. training a neural network model for implicit volumetric rendering, wherein said model is configured to generate simulated views from any point of said area-of-interest; and
d. generating terrain images by discarding occluding objects above ground level from the scene.

In embodiments of the method the overlapping images are captured using high overlap and density, wherein the density of the images is dependent on the density of the canopy.

In embodiments of the method the overlapping images are captured using a wide angular range of pixels from the nadir and oblique angles.

In embodiments of the method the overlapping images are captured during the twilight hours or under full cloud cover.

In embodiments of the method the overlapping images are captured using a high ground sample distance.

In embodiments of the method the overlapping images are captured under the same lighting conditions.

In embodiments of the method at least some of the overlapping images are captured at different altitudes.

In embodiments of the method at least some of the overlapping images are captured using different cameras.

In embodiments of the method at least some of the overlapping images are captured using cameras operating in different wavelength bands.

In embodiments of the method at least some of the overlapping images are captured using cameras operating in at least one of the following wavelength bands: middle infrared, near infrared, and visible.

In embodiments of the method at least some of the overlapping images are captured by two or more aerial platforms on the same day.

In embodiments of the method the overlapping images are captured by one or more aerial platforms on different days.

In embodiments of the method the aerial platform is a drone.

In embodiments of the method the parameters used in the bundle adjustment step include at least one of the following:
a) location of the aerial platform including: longitude, latitude, and altitude;
b) angles of the camera including: azimuth, pitch, and roll;
c) properties of the camera and lens including: focal length and image center; and
d) scene parameters including the three dimensional coordinates of objects in the scene that are observed in the images.

In embodiments of the method bundle adjustment is an iterative optimization process that involves refining the estimates of camera and scene parameters by minimizing the re-projection error.

In embodiments of the method the iterative optimization process uses one of the Levenberg-Marquardt algorithm or the Gauss-Newton algorithm.

In embodiments of the method training the model is done using implicit volumetric rendering.

In embodiments of the method the trained model is queried for views of the terrain below the canopy by invoke the rendering process only below a certain altitude.

In embodiments of the method the trained model is queried for views of the terrain below the canopy by a two-stage approach of obtaining a mask of the object/s to be removed followed by deletion of the object/s based on the mask. In these embodiments the mask can be obtained by usage of infrared channels in conjunction with the visible spectrum. In these embodiments the model can be trained on multiple color channels originating from different cameras.

In embodiments of the method the canopy is formed by trees in a forest, wood, or orchard.

In embodiments of the method the canopy is formed by agricultural crops.

In embodiments of the method the canopy is formed by a camouflaging or shade cover.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 is an aerial photograph showing a dense oak forest;

FIG. 2 shows a simulated RGB image of the illumination with light conditions simulating a 90 degree sun angle above the horizon;

FIG. 3 shows a simulated RGB image of the illumination with light conditions simulating a 5 degree sun angle above the horizon;

FIG. 4 schematically illustrates bundle adjustment;

FIG. 5 schematically illustrates the technique of implicit volumetric rendering;

FIGS. 6A to 6C show an example of using masks to remove the trees from an image during the Nerf training process;

FIGS. 7A and 7B show pealing of the trees from a section of forest using the MVS method;

FIGS. 8A and 8B show pealing of the trees from the same section of the forest using the presently disclosed method;

FIGS. 9A and 9B show pealing of the trees in the MIR band using the SAP method;

FIGS. 10A and 10b show pealing of the trees in the MIR band from the same section of the forest using the presently disclosed method;

FIG. 11 is an aerial photograph showing an area of interest;

FIG. 12 shows the locations of the flight lines overlaid on the aerial photograph of the area of interest;

FIG. 13 is a single image photographed with the optimal light conditions;

FIG. 14 shows the corresponding points between neighboring frames;

FIG. 15 shows the Agisoft bundle report;

FIG. 16 shows the entire area of interest after peeling the trees; and

FIG. 17 is a zoom-in to a small area before and after the peeling process.

### DETAILED DESCRIPTION OF EMBODIMENTS OF THE INVENTION

Disclosed herein is a method for revealing the surface of forests using regular RGB remote sensing. In some examples other spectral bands like infrared, which can be used for vegetation monitoring. As opposed to the synthetic aperture photography (SAP), which is only applied to the relatively small area in which it is suspected that there is present a target, the disclosed method involves generating a “ground pixel mosaic” that can cover a wide area, which in principle is unlimited in size. by using a series of overlapping images captured by a drone. The method includes four phases:
a. Image capturing: Images are captured using a drone with guidelines to be described herein below for increasing the chances of penetrating the tree canopy.
b. Bundle adjustment: This phase involves solving for the accurate parameters, e.g. camera positions, focal lengths, and lens distortions of the images that will be used in the next phase. The aim of this step is to obtain a highly precise presentation of the scene as will be described in more detail herein below.
c. Implicit volumetric rendering: This phase involves training a model to generate novel views of the scene without the occluding vegetation.
d. Once the model is trained, it can be queried for views revealing a ground pixel mosaic that do not include vegetation.

The ground mosaic can be exploited to detect objects and land-type segments. The method allows for further classification and analysis of the terrain, providing valuable information about the vegetation, topography, and other features of the forest that can be applied to all of the applications listed in the background section of this application.

The phases of the method will now be described in more detail.

### First Phase:

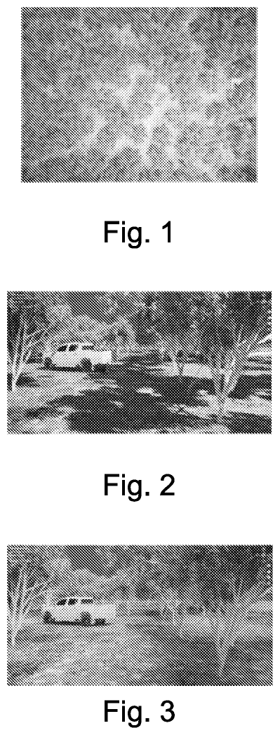

The first phase of the method involves capturing images using a drone flying repeated parallel passes over the section of forest being investigated. The inventors have identified certain guidelines for image capturing that should be followed to increase the chances of penetrating the tree canopy and seeing the surface underneath. These guidelines include:
High image overlaps and density: For forest surface mapping projects, both the forward and side density of images and their corresponding footprint overlap need to be considered for effective tree penetration. The necessary density of images is dependent on the density of the forest and is expressed in meters.
As an example, FIG. 1 is an aerial photograph showing a dense oak forest that the inventors selected for a test of the method. In this example, they found that a forward density of an image every 2 meters with a 95% footprint overlap and a side density of every 25 meters with 90% footprint overlap effectively reconstructed the forest ground surface. The approach of using two parameters that determine the mission plan—i.e. footprint overlap and camera density, avoids the variability introduced by using just footprint overlap, as is usually the common parameter for planning an aerial photography mapping project, which can vary between cameras and flight altitudes.
A wide angular range of pixels from the nadir and oblique angles: The nadir angle is the angle directly below the drone, and is the most important for tree penetration. Oblique angles are those that are not directly below the drone. They provide additional information about the terrain by increasing the penetration and accuracy of the model. Capturing the images with high image density and overlap should produce many nadir views.
Capturing images during the twilight hours or under full cloud cover: This guideline is necessary since sharp light changes between shaded areas and open areas exposed to the sun can interrupt the ground pixel restoration process. This is shown in FIG. 2, which shows a simulated RGB image of the illumination with light conditions simulating a 90 degree sun angle above the horizon. To avoid this, the inventors recommend capturing images during the twilight hours or under full cloud cover, which reduces the amount of direct sunlight in the images. The effect of following this recommendation is seen in FIG. 3, which shows a simulated RGB image of the illumination with light conditions simulating a 5 degree sun angle above the horizon.
High GSD resolution. GSD, or ground sample distance, is a measure of the spatial resolution of the images. A higher GSD means that each pixel in the image represents a smaller area on the ground, providing more detailed information about the terrain. High GSD also provides a higher potential for penetrating the forest canopy as pixel size will be smaller than a typical leaf or the gaps between them. The inventors conducted a test using simulation and were able to reconstruct the ground surface also by using images with a 1 cm GSD to a 4 cm GSD.
additional conditions are:
   All images should be taken under the same lighting conditions.
   It is not necessary that all images are taken from the same altitude although this is the more common practice.
   It is not necessary that all images are taken using the same camera.
   Images from several different cameras operating in the same or in different wavelength bands, e.g. MIR, NIR, RGB, can be used in the method.
   Images can be recorded by two or more drones on the same day or by one or more drones on different days.

Capturing images following these guidelines increases the chance of penetrating the tree foliage and the chance of being able to see what's underneath it. This is essential for generating a high-quality ground pixel mosaic.

### Second Phase:

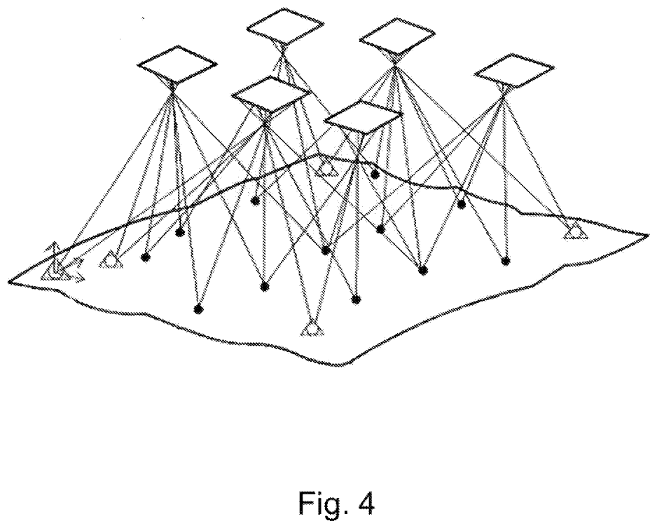

The second phase of the method is bundle adjustment. Bundle adjustment, which is schematically illustrated in FIG. 4, is the process of solving for the accurate parameters of the images that were captured in the first phase. These parameters are used as an input in the neural radiance field algorithm to later generate an accurate and detailed scene.

The parameters of the images at any given time are defined as the location (i.e., longitude, latitude, altitude), angles (i.e., azimuth, pitch, roll), and optical parameters. These parameters provide information about the position and orientation of the drone at the time the images were captured, as well as the characteristics of the camera and lens.

Solving for the accurate parameters of the images is an important step in generating a high-quality ground pixel mosaic. It ensures that the images are aligned and consistent, which is necessary for generating a coherent and accurate implicit volumetric rendering and depth map.

Solving for the parameters in the context of bundle adjustment refers to the process of refining the initial estimates of camera and scene parameters to improve the accuracy of the 3D reconstruction from the images captured in the first phase.

The camera parameters depend upon the type of camera and typically include intrinsic parameters such as, for example, the focal length, image center, and radial distortion, as well as extrinsic parameters such as the position and orientation of the camera in space. The scene parameters typically include the 3D coordinates of the tie points in the scene that were observed in the images.

Bundle adjustment is an iterative optimization process that seeks to minimize the re-projection error, which is the difference between the observed image points and the projected 3D points in the images, taking into account the uncertainties in the measurements and the estimated parameters. The optimization can be done using various techniques, such as the Levenberg-Marquardt algorithm or Gauss-Newton algorithm.

In summary, solving for the parameters in bundle adjustment involves refining the estimates of camera and scene parameters by minimizing the re-projection error in an iterative optimization process.

### Third Phase:

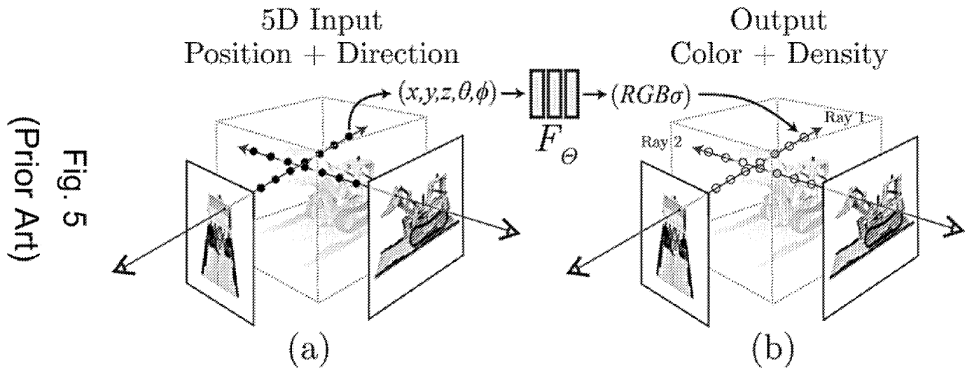

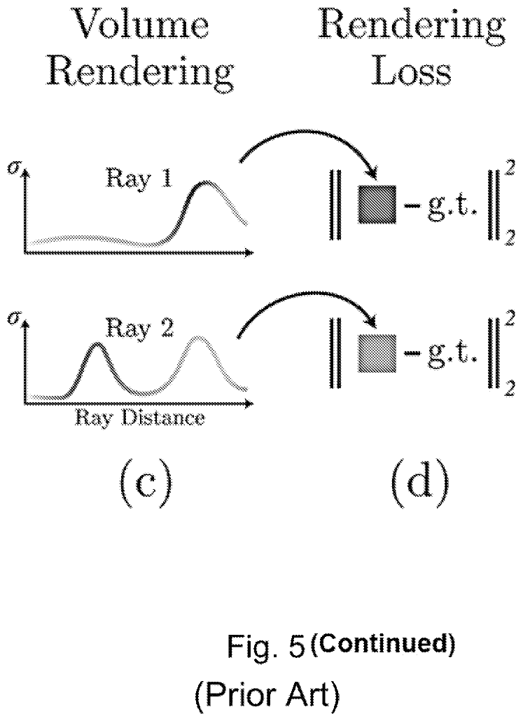

In the third phase of the method, a technique called implicit volumetric rendering is used to generate novel views of the scene without the occluding vegetation. This technique involves fitting, or training, of a model that can render the given images accurately. The technique is described in an article by Mildenhall, et al. (2020) [1] and illustrated schematically in FIG. 5 reproduced from that publication. The training process encourages the model to correctly render the images and penalizes any incorrect rendering results.

### Fourth Phase:

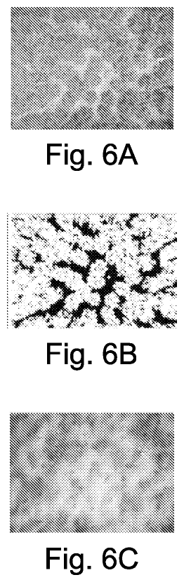

Once the model is trained, it can be queried for views that do not include vegetation, allowing the surface of the forest to be revealed. There are several ways to discard the vegetation in these views. Two examples are:
One can invoke the rendering process only below a certain altitude, which ignores tall elements like treetops. Specifically, if the “z”-axis represents altitude, points whose z-coordinate is above the height of the ground are ever sampled.
A two-stage approach of occlude annotation followed by its deletion: First, one obtains the mask of the object to be removed. While this can be done manually, recent methods, e.g. Fan, Z. a., et al. (2022) [2], show that this can be done automatically. The second part is removing the occluded object or objects based on the mask. FIGS. 6A to 6C show an example of using masks to remove the trees from an image; wherein FIG. 6A shows the original image, FIG. 6B shoes the mask, and FIG. 6C shows the peeled image. While similar approaches like Liu, H-K, et al. (2022) [3] and Mirzaei, Ashkan, et al. (2022) [4] show such removal, the inventors emphasize that this needs to be done in a physical manner to prevent hallucination details. i.e. predicting existence of items for which there is no physical evidence, of the occluded surface.
A physical method to obtain the mask can be the usage of infrared channels in conjunction with the visible spectrum, as done in the “Normalized difference vegetation index” (NDVI). The model can be trained on multiple color channels originating from different cameras as was done by Poggi, Matteo (2022) [5].

This phase of the method is crucial for revealing the surface of forests and providing valuable information about the terrain. It allows us to generate novel views of the scene without the occluding vegetation, providing a more accurate representation of the terrain and supporting the other phases of our method.

Using implicit methods, i.e. the process of rendering the entire scene, is the key in uncovering the ground, especially when compared with existing methods (such as Multiview stereo) that require extra assumption on the scene such as local smoothness, which cannot be assumed for vegetation.

In addition to detecting and classifying natural features in the forest, the disclosed method can also be used to detect and classify human-made features and activities. For example, the ground pixel mosaic and depth maps generated in our method can be used to identify and classify humans, man-made object, trails, and other human-made paths in the forest.

The novelty and inventive step of the disclosed method is the combination of image capture techniques, photography methodologies, and a unique solution to the challenge of revealing the surface of dense forests. The approach described herein is different from other solutions in the field in several ways.

Firstly, the method uses implicit volumetric rendering to accurately render the scene without making any pre-assumptions, unlike other multi-view stereo (MVS) algorithms or other papers like the one of Schedl, D. K. 2020) which use synthetic aperture photography (SAP) to find humans in a dense forest. Their approach is capable of achieving results only using thermal images and revealing objects (humans) that exhibit a large thermal anomaly relative to their surrounding area while implicit volumetric rendering allows the reconstruction of complex scenes with greater detail and accuracy.

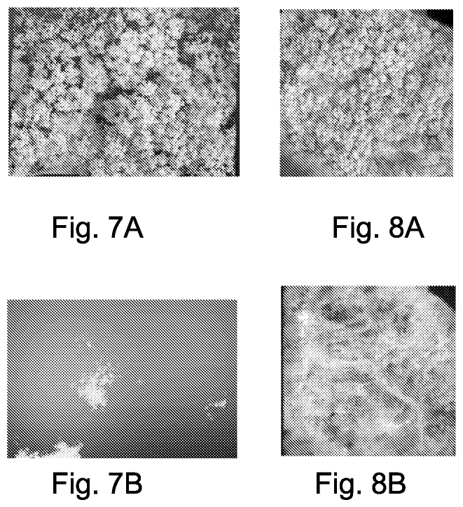

FIGS. 7A and 7B show pealing of the trees from a section of forest using the MVS method. FIGS. 8A and 8B show pealing of the trees from the same section of the forest using the presently disclosed method.

Note that with the MVS method, nearly all terrain features of the forest floor are missing while with the presently disclosed method many features including trails are clearly revealed on the forest floor.

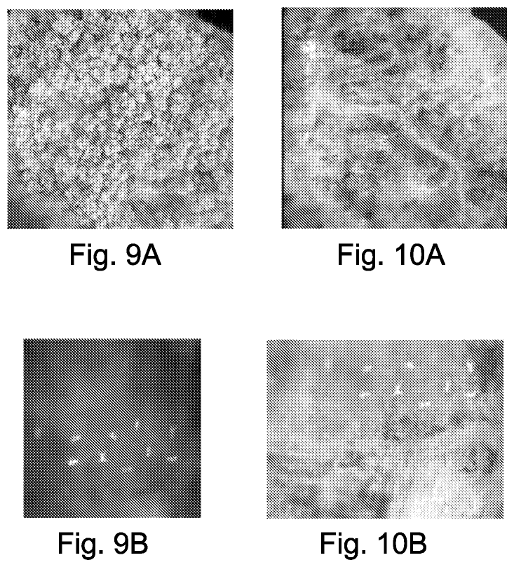

FIGS. 9A and 9B show pealing of the trees in the MIR band using the SAP method. FIGS. 10A and 10b show pealing of the trees in the MIR band from the same section of the forest using the presently disclosed method. FIG. 10A shows rendering of the scene by an orthographic camera and without the process of removing the occluded vegetation while FIG. 10B is the same scene using the same orthographic camera after the process of removing the occluded vegetation.

Note that using the SAP method the humans lying on the forest floor are clearly revealed; however no other features of the terrain are seen. In contrast, using the presently disclosed method both the humans and terrain features are visible.

Secondly, the present method handles the peeling phase, where images are processed to remove occluding vegetation, differently from other approaches. In other methods, the images are placed on a uniform plane after the solution, producing a unified image that contains all the pixels. This image highlights objects with high contrast to their surroundings, but the rest of the image may appear out of focus. In contrast, the present method involves deleting the trees and rendering the entire scene captured beneath them. This allows for a clear view of the entire area and the objects on it, without the need for additional post-processing or assumptions about the scene. The only dependencies are on the flight parameters, photography parameters, and the density of the trees.

A detailed description of a tree peeling experiment will now be described.

### 1. Description of the Experimental Site

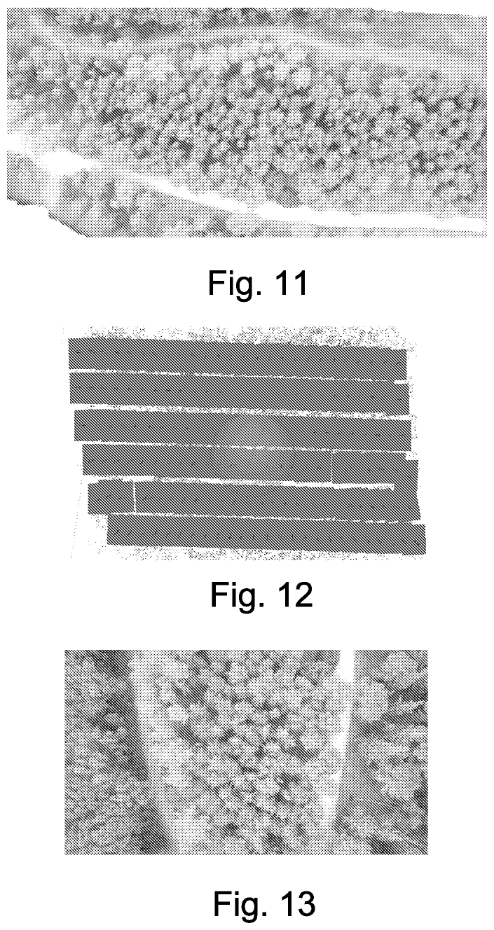

The experimental site is predominantly populated by mature pine trees and cypress trees. Beneath these trees, various shrubs and other types of vegetation can be found. The area is frequently traversed by individuals, leaving the majority of the ground exposed, with no clear paths. The site, rectangular in shape, measures approximately 250 meters in length and 50 meters in. The density of the trees in this area is notably high. FIG. 11 is an aerial photograph showing the area of interest.

### 2. Image Capturing Process

The image capturing operation was executed on Thursday, May 11, 2023.
The aerial photography was carried out using a DJI Mavic Mini 2 drone. The operation was strategically conducted immediately following sunset to take advantage of optimal lighting conditions. The drone was flown at an altitude of 90 meters above ground level, corresponding to a Ground Sample Distance (GSD) of 3.2 cm. FIG. 13 is a single image photographed with the optimal light conditions described.
During the flight, a total of 155 images were captured. These images were distributed across six distinct flight paths. A significant overlap of 90% was maintained between each path, resulting in an average distance of approximately 13 meters between each path. Within each individual flight line, the overlap between consecutive images was maintained at 95%. This corresponded to an approximate distance of 5 meters from one camera position to the next. FIG. 12 shows the locations of the flight lines overlaid on the aerial photograph of the area of interest. The dashes on the flight lines symbolically show the locations of the camera position for each of the images.

### 3. Processing Step

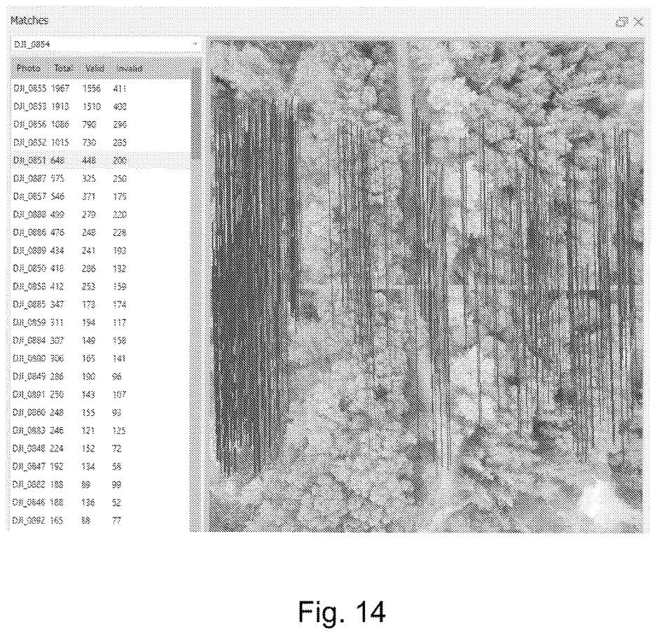

Camera Alignment is carried out using Agisoft Metashape software developed by Agisoft LLC. The captured images are fed into this software, which uses a feature matching algorithm to identify the same point across multiple images. From this, it computes the relative positions and orientations (6 DOF—Degrees of Freedom) of the cameras used to capture the images. FIG. 14 shows the corresponding points between neighboring frames.

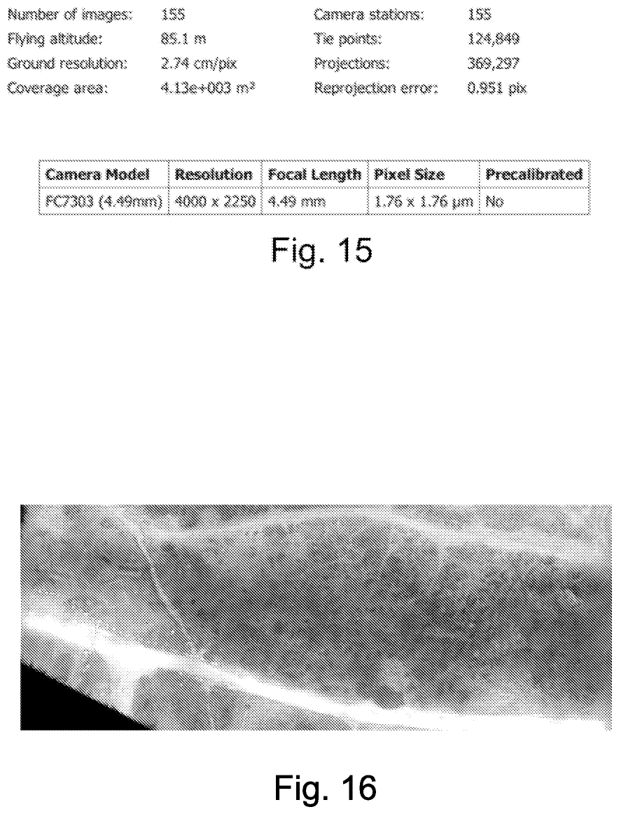

Parameter Estimation: Once the software has the camera parameters (location and orientation), it refines them using a bundle adjustment algorithm. This optimization process minimizes the reprojection error, which is the difference between the observed and predicted image points. FIG. 15 shows the Agisoft bundle report.

Using Parameters for NeRF: The camera parameters refined by Agisoft are then used as input to the Neural Radiance Fields algorithm (NeRF), which constructs a 3D model of the scene.

Training with NeRF:

After feeding the refined camera parameters into NeRF, the algorithm is trained to understand the 3D structure of the scene.

$${\int }_{{t}_{1}}^{{t}_{2}} T ( t ) σ ( t ) c ( t , d ) dt$$

Equation 1—is the ray-rendering function that guides the NeRF algorithm during training. t₁ and t₂ are the start and end position of the ray, respectively. T is the transmission function, which represents occlusions. σ and c are the density and color functions.

After the NeRF training, an image of the entire scene is synthesized without any cropping. This image gives a complete view of the area of interest and its surroundings.

Now, a new image is synthesized. This time, however, a Digital Terrain Model (DTM) is used to guide the cropping process. This allows elimination all non-relevant volume from the scene (in this case the trees) and focus on rendering a scene that contains only ground pixels

$${\int }_{{t}_{veg}}^{{t}_{2}} T ( t ) σ ( t ) c ( t , d ) dt$$

Equation 2—is a modified version of Eq. 1 used during peeling and ground mosaic generation. Note that here the integration starts at t_{veg} rather than t₁, i.e. after the vegetation rather than at the camera position.

FIG. 16 shows the entire area of interest after peeling the trees.

### 4. Results

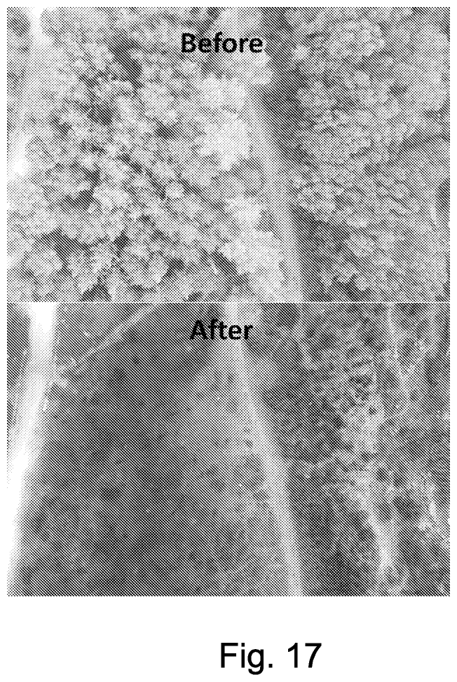

FIG. 17 is a zoom-in to a small area before (top image) and after (bottom image) the peeling process. The results demonstrate the ability of the method and algorithm to expose ground surfaces in forested areas. As can be seen from the examples, the exposure of the surface enables the identification of trails, rocks, exposed ground areas, or those covered by bushes, and to perform analysis and management of protected areas in an efficient and innovative manner.

Herein, the method has been described as being used to image the terrain under densely forested areas; however it is noted that the same method can be used in other scenarios. For example, in agriculture to disclose the terrain under crops, e.g. an orchard, vineyard, or field of corn or sunflowers; and in law enforcement to reveal objects, e.g. stolen cars, hidden beneath a camouflaging cover.

Although embodiments of the invention have been described by way of illustration, it will be understood that the invention may be carried out with many variations, modifications, and adaptations, without exceeding the scope of the claims.

### BIBLIOGRAPHY

[1] Mildenhall, Ben, et al. (2020); NeRF: Representing Scenes as Neural Radiance Fields for View Synthesis; Retrieved from https://arxiv.org/abs/2003.08934.
[2] Fan, Z. a., et al. (2022); NeRF-SOS: Any-View Self-supervised Object Segmentation on Complex Scene; Retrieved from https://arxiv.org/abs/2209.08776.
[3] Liu, H-K, et al. (2022); NeRF-In: Free-Form NeRF Inpainting with RGB-D Priors; Retrieved from https://arxiv.org/abs/2206.04901.
[4] Mirzaei, Ashkan, et al. (2022); SPIn-NeRF: Multiview Segmentation and Perceptual Inpainting with Neural Radiance Fields; Retrieved from https://arxiv.org/abs/2211.12254.
[5] Poggi, Matteo, et al., (2022); Cross-Spectral Neural Radiance Fields; Retrived from: https://arxiv.org/abs/2209.00648.
[6] Schedl, D. K., et al (2020); Search and rescue with airborne optical sectioning; Nat Mach Intell.; Retrieved from https://www.flir.com/discover/cores-components/researchers-develop-search-and-rescue-technology-that-sees-through-forest-with-thermal-imaging.

1. A method for constructing under-the-canopy terrain imagery, the method comprising the steps:
a. capturing overlapping images to cover an area-of-interest from an imaging sensor on an aerial platform;
b. performing bundle adjustment utilizing parameters of said imaging sensor at any given point of capturing the images;
c. training a neural network model for implicit volumetric rendering, wherein said model is configured to generate simulated views from any point of said area-of-interest; and
d. generating terrain images by discarding occluding objects above ground level from the scene.

2. The method of claim 1, wherein the overlapping images are captured using high overlap and density, wherein the density of the images is dependent on the density of the canopy.

3. The method of claim 1, wherein the overlapping images are captured using a wide angular range of pixels from the nadir and oblique angles.

4. The method of claim 1, wherein the overlapping images are captured during the twilight hours or under full cloud cover.

5. The method of claim 1, wherein the overlapping images are captured using a high ground sample distance.

6. The method of claim 1, wherein the overlapping images are captured under the same lighting conditions.

7. The method of claim 1, wherein at least some of the overlapping images are captured at different altitudes.

8. The method of claim 1, wherein at least some of the overlapping images are captured using different cameras.

9. The method of claim 1, wherein at least some of the overlapping images are captured using cameras operating in different wavelength bands, selected from middle infrared, near infrared, and visible.

10. (canceled)

11. The method of claim 1, wherein at least some of the overlapping images are captured by two or more aerial platforms on the same day.

12. The method of claim 1, wherein the overlapping images are captured by one or more aerial platforms on different days.

13. The method of claim 1, wherein the aerial platform is a drone.

14. The method of claim 1, wherein the parameters used in the bundle adjustment step include at least one of the following:
a) location of the aerial platform including: longitude, latitude, and altitude;
b) angles of the camera including: azimuth, pitch, and roll;
c) properties of the camera and lens including: focal length and image center; and
d) scene parameters including the three dimensional coordinates of objects in the scene that are observed in the images.

15. The method of claim 1, wherein bundle adjustment is an iterative optimization process that involves refining the estimates of camera and scene parameters by minimizing the re-projection error, selected from Levenberg-Marquardt algorithm or the Gauss-Newton algorithm.

16. (canceled)

17. The method of claim 1, wherein training the model is done using implicit volumetric rendering.

18. The method of claim 1, wherein the trained model is queried for views of the terrain below the canopy by invoking the rendering process only below a certain altitude.

19. The method of claim 1, wherein the trained model is queried for views of the terrain below the canopy by a two-stage approach of obtaining a mask of the object/s to be removed followed by deletion of the object/s based on the mask.

20. The method of claim 19, wherein the mask is obtained by usage of infrared channels in conjunction with the visible spectrum.

21. The method of claim 20, wherein the model is trained on multiple color channels originating from different cameras.

22. The method of claim 1, wherein the canopy is selected from a canopy formed by trees in a forest, wood, or orchard, by agricultural crops, or by a camouflaging or shade cover.

23. (canceled)

24. (canceled)
